(19) United States
(12) Patent Application Publication
(10) Pub. No.: US 2003/0034073 A1
(43) Pub. Date: Feb. 20, 2003

(54) Check valve for fuel pump

(76) Inventor: Robert A. Roth, Grand Blanc, MI (US)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 09/992,079

(22) Filed: Nov. 19, 2001

Related U.S. Application Data
(60) Provisional application No. 60/312,855, filed on Aug. 16, 2001.

(51) Int. Cl. F16K 15/00

(52) U.S. Cl. 137/541

(57) ABSTRACT

A check valve for a fuel pump of a vehicle includes a valve housing adapted to be disposed in an outlet member of the fuel pump and a valve seat formed on the valve housing. The check valve also includes a valve member disposed in the valve housing and having a closed position to operatively engage the valve seat to prevent fuel from flowing through the outlet member and an open position to allow fuel to flow through the outlet member. The valve member also has a single outlet port to allow flow from the valve member when the valve member is in the open position.

### CROSS-REFERENCE TO RELATED APPLICATION(S)

The present invention claims the priority date of copending U.S. Provisional Patent Application Serial No. 60/312,855, filed Aug. 16, 2001.

### TECHNICAL FIELD

The present invention relates generally to fuel pumps for vehicles and, more particularly, to a check valve for a fuel pump of a vehicle.

### BACKGROUND OF THE INVENTION

It is known to provide a fuel tank in a vehicle to hold fuel to be used by an engine of the vehicle. It is also known to provide a fuel pump inside the fuel tank to pump fuel to the engine. Typically, the fuel pump includes a check valve to allow unhindered flow of fuel in a forward direction to exit the fuel pump and prevent or check the flow of fuel in a reverse direction or back into the fuel pump. The check valve maintains a complete column of fuel in a fuel line between the fuel pump and the engine on shutdown, resulting in rapid pressurization of this fuel with key-on for quick engine starting.

There are several types of checking devices including, but not limited to, a bullet nose valve and a ball valve. One type of check valve having a relatively low cost includes a machined housing, a return spring, a molded or machined pintel, and an o-ring. One advantage of this check valve is its relatively low cost compared to insert molded bullet nose valves. In this check valve, flow passes through the pintel and exits through two outlet ports being opposed or 180 degrees apart. However, this check valve has proven to be unstable at a wide range of flows. The flow through this check valve creates eddy currents as it passes around the end of the pintel. These eddy currents tend to create a low pressure on one side of the pintel. This low-pressure area causes the pintel to tip toward this low pressure. Once the pintel moves toward the low-pressure area, the low-pressure area alternates to the opposite side of the pintel. This causes the pintel to immediately move back one hundred eighty degrees (180°) from its original direction of travel. As a result, the pintel is constantly trying to reach positional equilibrium, causing the pintel to oscillate and produce objectionable noise. This check valve is also restrictive at high flow rates and attempts to reduce the restriction by enlarging the two outlet ports increases the instability of the pintel.

Therefore, it is desirable to provide a check valve in a fuel pump for a vehicle that is stable at a wide range of flows. It is also desirable to provide a check valve for a fuel pump that is not restrictive at high flow rates. It is further desirable to provide a check valve for a fuel pump that is less noisy and relatively low cost.

### SUMMARY OF THE INVENTION

It is, therefore, one object of the present invention to provide a new check valve for a fuel pump of a vehicle.

It is another object of the present invention to provide a check valve for a fuel pump that is stable at a wide range of flows and reduces objectionable noise.

It is yet another object of the present invention to provide a check valve for a fuel pump that has relatively low noise and cost.

To achieve the foregoing objects, the present invention is a check valve for a fuel pump of a vehicle including a valve housing adapted to be disposed in an outlet member of the fuel pump and a valve seat formed on the valve housing. The check valve also includes a valve member disposed in the valve housing and having a closed position to operatively engage the valve seat to prevent fuel from flowing through the outlet member and an open position to allow fuel to flow through the outlet member. The valve member also has a single outlet port to allow flow from the valve member when the valve member is in the open position.

One advantage of the present invention is that a new check valve is provided for a fuel pump of a vehicle. Another advantage of the present invention is that the check valve has a mono-port on the pintel, which reduces oscillations and objectionable noise. Yet another advantage of the present invention is that the check valve has a mono-port that forces all the flow to exit on just one side of the pintel, making the pintel extremely stable. Still another advantage of the present invention is that the check valve has a single outlet port whose size and shape can be configured to drastically reduce a restriction, while still maintaining pintel strength. A further advantage of the present invention is that the check valve has relatively low noise and cost.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a check valve, according to the present invention, illustrated in operational relationship with a fuel pump.

FIG. 2 is an enlarged fragmentary elevational view of the check valve of FIG. 1 illustrating a closed position.

FIG. 3 is a view similar to FIG. 2 illustrating an open position of the check valve.

FIG. 4 is a graph of flow versus pressure for several conventional check valves and the check valve, according to the present invention.

### DESCRIPTION OF THE PREFERRED EMBODIMENT

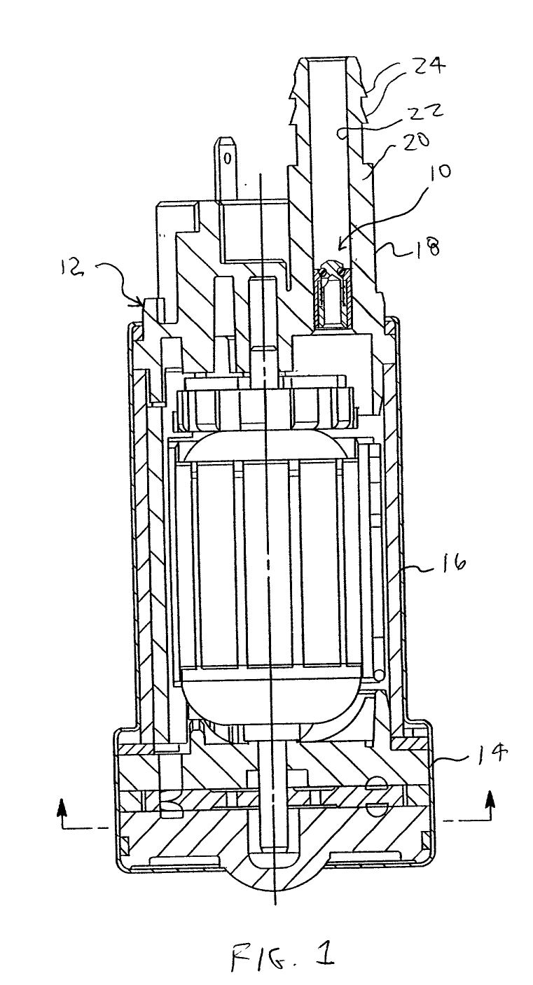

Referring to the drawings and in particular FIGS. 1 through 3, one embodiment of a check valve 10, according to the present invention, is shown for a fuel pump, generally indicated at 12, of a vehicle (not shown). The fuel pump 12 includes a pump section 14 at one axial end, a motor section 16 adjacent the pump section 14 and an outlet section 18 adjacent the motor section 16 at the other axial end. As known in the art, fuel enters the pump section 14, which is rotated by the motor section 16, and is pumped past the motor section 16 to the outlet section 18. The outlet section 18 has an outlet member 20 extending axially with a passageway 22 extending axially therethrough. The outlet member 20 also has a plurality of projections or barbs 24 extending radially outwardly for attachment to a conduit (not shown). The outlet member 20 also receives the check valve 10 to be described in the passageway 22. It should be appreciated that the fuel flowing to the outlet section 18 flows into the outlet member 20 and through the passageway 22 and the check valve 10 when open to the conduit. It should also be appreciated that, except for the check valve 10, the fuel pump 12 is conventional and known in the art.

Referring to FIGS. 1 through 3, the check valve 10 includes a valve housing 26 extending axially and disposed in the passageway 22 of the outlet member 20. The valve housing 26 has a body portion 28 that is generally tubular in shape and has a generally circular cross-sectional shape. The body portion 28 extends axially and has a passageway 30 extending axially therethrough with a stepped enlarged portion or cavity 32 at one end. The valve housing 26 is made of a rigid material such as metal or plastic. It should also be appreciated that the valve housing 26 is a monolithic structure being integral, unitary, and one-piece.

The check valve 10 includes a valve seat 34 disposed at the other end of the valve housing 26. The valve seat 34 is formed on the body portion 28 and has a generally frusta-conical cross-sectional shape. The valve seat 34 extends axially and communicates with the passageway 30 for a function to be described. The valve seat 34 is made of a rigid material such as metal or plastic. It should be appreciated that the valve seat 34 is formed with the valve housing 26 as a monolithic structure being integral, unitary, and one-piece.

The check valve 10 also includes a valve member 36 disposed within the valve housing 26 and cooperating with the valve seat 34. The valve member 36 is of a pintel type and extends axially. The valve member 36 has a body portion 38 that is generally tubular in shape and has a generally circular cross-sectional shape. The body portion 38 extends axially and has a cavity or flow port 40 extending axially into one end thereof. The body portion 38 also has a single aperture or outlet port 42 extending diametrically therethrough and communicating with the flow port 40. The body portion 38 also has a stepped enlarged portion 44 at the end adjacent the flow port 40. The valve member 36 also includes an annular groove 46 at the other end thereof for a function to be described. The valve member 36 is made of a rigid material such as metal or plastic.

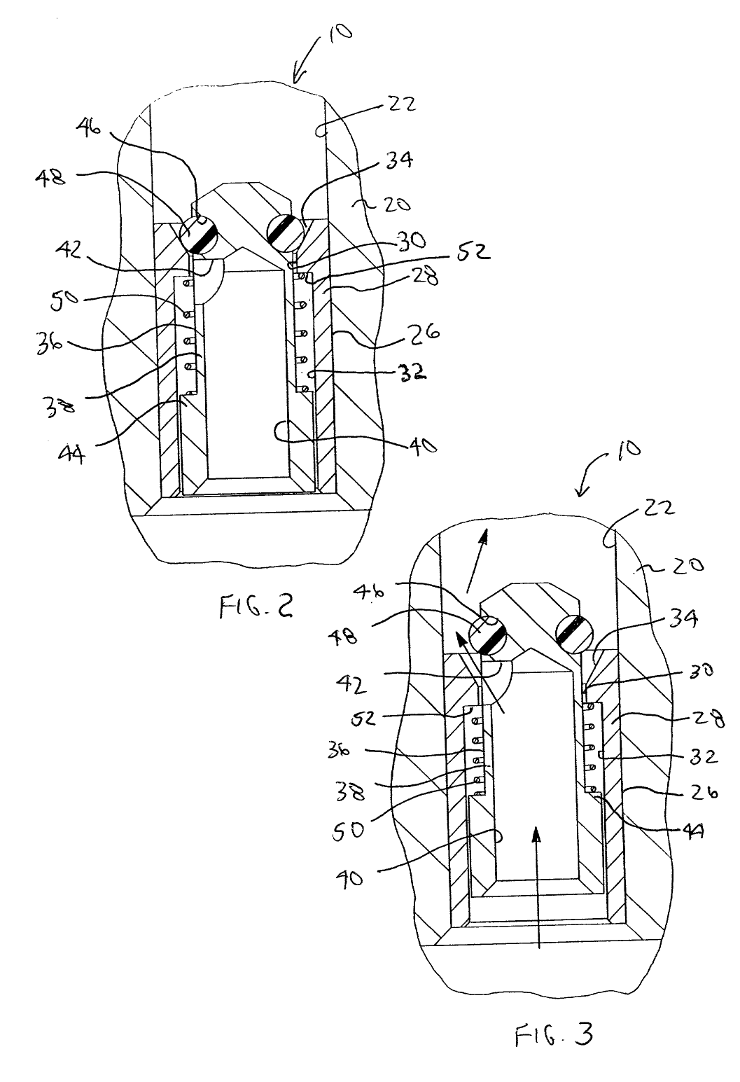

The check valve 10 includes a seal 48 disposed in the groove 46 of the valve member 36. The seal 48 is of an o-ring type and is generally circular in shape with a generally circular cross-sectional shape. The seal 48 is made of a flexible material such as an elastomeric material. The seal 48 extends radially to engage the valve seat 34. The valve member 36 has a first or closed position in which the seal 48 engages the valve seat 34 to close the passageway 30 as illustrated in FIG. 2. The valve member 36 has a second or open position in which the seal 48 disengages the valve seat 34 to open the passageway 30 as illustrated in FIG. 3. It should be appreciated that fluid such as fuel flows into the flow port 40, out the outlet port 42, past the valve member 36 and seal 48, and through the passageway 22 when the valve member 36 is in the open position as illustrated in FIG. 3. It should also be appreciated that the valve member 36 has a mono-port flow through design.

The check valve 10 further includes a spring 50 to urge the valve member 36 toward the valve seat 34. The spring 50 is of a coil type. The spring 50 is disposed in the cavity 32 of the valve housing 26 and about the valve member 36 between the enlarged portion 44 of the valve member 36 and a shoulder 52 of the valve housing 26. It should be appreciated that the spring 50 urges the valve member 36 and seal 48 to engage the valve seat 34 in a closed position. It should also be appreciated that the spring 50 is conventional and known in the art.

In operation, the check valve 10 is illustrated in an assembled state in which the valve housing 26 is disposed in the passageway 22 of the outlet member 20 of the fuel pump 12. The valve member 36 and seal 48 engage the valve seat 34 in the closed position as illustrated in FIG. 2. The valve member 36 and seal 48 are contained on the valve seat 34 by the spring force of the spring 50.

During high forward flow conditions, the valve member 36 is dislodged from the seated position and travels in the flow direction away from the valve seat 34. Fuel enters the outlet member 20 when the fuel is pumped by the pump section 14 past the motor section 16 to the outlet section 18. In normal operating conditions where the flow of the fuel pump 12 is greater than 20 kPa. to the check valve 10, fuel flows, as indicated by the arrows in FIG. 3, to the flow port 40 of the valve member 36 and causes the valve member 36 to move away from the valve seat 34. The valve member 36 moves to an open position, which is the maximum position desired off of the valve seat 34. In the open position, the valve member 36 allows fuel to flow through the outlet port 42. Fuel flows past the valve seat 34 and seal 48 through the passageway 22 of the outlet member 20 to the conduit. In the open position, the valve member 36 is contained and retained in the center of the fuel flow stream by the enlarged portion 44 in the cavity 32, which guides the enlarged portion 44 of the valve member 36. At low flow conditions, the position of the valve member 36 is determined by the spring rate of the spring 50 and distance of the valve member 36 off of the valve seat 34. In the open or retained position, the valve member 36 has a low co-efficient of drag and low flow restriction versus differential pressure across the valve member 36 compared to current conventional check valves. It should be appreciated that the single outlet port 42 results in a vast majority of eddy currents on only one side of the valve member 36, causing the force on the valve member 36 to be consistently one sided, and always on the same side of the valve member 36. It should also be appreciated that this unequal force virtually eliminates any oscillations that the valve member 36 produces, thus eliminating noise generated by the valve.

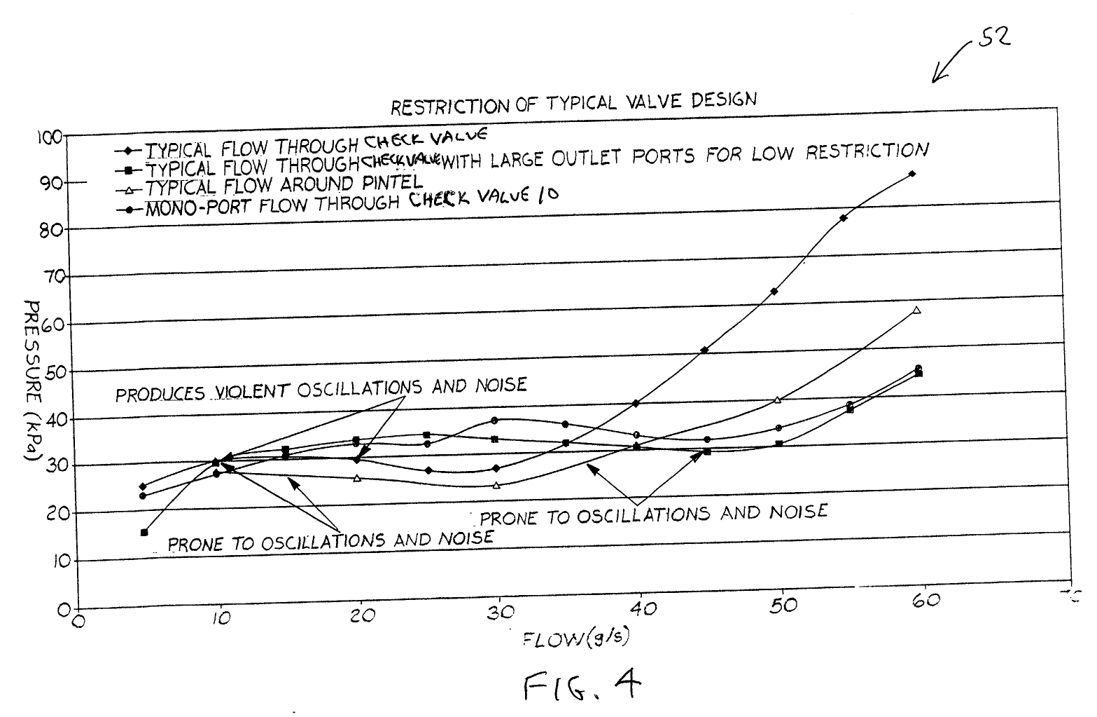

Referring to FIG. 4, a graph 52 of flow (g/s) versus pressure (kPa) is shown for the check valve 10 and typical conventional check valves. The check valve 10 has less restriction at high flow rates than conventional flow through check valves or conventional flow through check valves with enlarged outlet ports. The check valve 10 has a single outlet port 42 with a size and shape that can be tailored to produce low backpressure restriction at high flow rates without causing noise-producing instability as illustrated in FIG. 4.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A check valve for a fuel pump of a vehicle comprising:
a valve housing adapted to be disposed in an outlet member of the fuel pump;
a valve seat formed on said valve housing;
a valve member disposed in said valve housing and having a closed position to operatively engage said valve seat to prevent fuel from flowing through the outlet member and an open position to allow fuel to flow through the outlet member; and
said valve member having a single outlet port to allow flow from said valve member when said valve member is in said open position.

2. A check valve as set forth in claim 1 wherein said valve housing has a passageway extending axially therethrough to receive said valve member.

3. A check valve as set forth in claim 2 wherein said valve housing has an enlarged opening at one end of said passageway.

4. A check valve as set forth in claim 1 wherein said valve member has a flow port extending axially into one end thereof.

5. A check valve as set forth in claim 2 wherein said outlet port extends radially through said valve member and communicates with said flow port.

6. A check valve as set forth in claim 1 including a spring disposed about said valve member to urge said valve member toward said valve seat.

7. A check valve as set forth in claim 6 wherein said spring comprises a coil spring.

8. A check valve as set forth in claim 1 wherein said valve member includes an annular groove adjacent said valve seat.

9. A check valve as set forth in claim 8 including a seal disposed in said groove.

10. A check valve as set forth in claim 1 wherein said seal is made of an elastomeric material.

11. A check valve for a fuel pump of a vehicle comprising:
a valve housing adapted to be disposed in an outlet member of the fuel pump;
a valve seat formed on said valve housing;
a valve member disposed in said valve housing and having an annular groove adjacent said valve seat and including a seal disposed in said groove, said valve member having a closed position in which said seal engages said valve seat to prevent fuel from flowing through the outlet member and an open position to allow fuel to flow through the outlet member; and
said valve member having a single outlet port to allow flow from said valve member when said valve member is in said open position.

12. A check valve as set forth in claim 11 wherein said valve housing has a passageway extending axially therethrough to receive said valve member.

13. A check valve as set forth in claim 11 wherein said valve housing has an enlarged opening at one end of said passageway.

14. A check valve as set forth in claim 11 wherein said valve member has a flow port extending axially into one end thereof.

15. A check valve as set forth in claim 14 wherein said outlet port extends radially through said valve member and communicates with said flow port.

16. A check valve as set forth in claim 11 including a spring disposed about said valve member to urge said valve member toward said valve seat.

17. A check valve as set forth in claim 17 wherein said spring comprises a coil spring.

18. A check valve as set forth in claim 11 wherein said seal is made of an elastomeric material.

19. A check valve for a fuel pump of a vehicle comprising:
a valve housing adapted to be disposed in an outlet member of the fuel pump;
a valve seat formed on said valve housing;
a valve member disposed in said valve housing and having an annular groove adjacent said valve seat and including a seal disposed in said groove;
a spring disposed about said valve member to urge said valve member toward said valve seat in a closed position in which said seal engages said valve seat to prevent fuel from flowing through the outlet member; and
said valve member having a single outlet port to allow flow from said outlet port when said valve member is in an open position to allow fuel to flow through the outlet member.

20. A check valve as set forth in claim 19 wherein said valve member has a flow port extending axially into one end thereof and said outlet port extends radially through said valve member and communicates with said flow port.
